(19) United States
(12) Patent Application Publication
(10) Pub. No.: US 2013/0076980 A1
(43) Pub. Date: Mar. 28, 2013

(54) SYSTEMS AND METHODS FOR SYNCHRONIZING THE PRESENTATION OF A COMBINED VIDEO PROGRAM

(71) Applicants: Amichay Oren, Rosh-a-ayin (IL); Tzahi Efrati, Givataim (IL); Baruch Sterman, Efrat (IL)

(72) Inventors: Amichay Oren, Rosh-a-ayin (IL); Tzahi Efrati, Givataim (IL); Baruch Sterman, Efrat (IL)

(21) Appl. No.: 13/244,918

(22) Filed: Sep. 26, 2011

(51) Int. Cl. H04N 5/04

(52) U.S. Cl. 348/500; 348/E05.009

(57) ABSTRACT

A system and method for synchronizing the presentation of a video program on multiple display devices makes use of a synchronized content distribution unit that receives a video program from a content provider as well as text, audio and/or video feeds from at least one user. The video program and the text, audio and/or video feeds are combined, and the combined program is then distributed to the display screens. Synchronization information may be encoded in the combined program, and this information may be used by the display screens or video controller associated with the display screens to cause the combined video program to be displayed on all the display screens in a synchronized fashion.

### BACKGROUND OF THE TECHNOLOGY

The technology is related to systems and methods that are used to synchronize the display of content on multiple displays screens or televisions that are in different locations.

Televisions and other similar display devices can now receive video programming from different sources. For example, a television could receive broadcast signals from multiple television broadcasters. Alternatively, a television could receive video programming from a cable television service provider or from a satellite television service provider. In still other instances, a television could receive video programming via the Internet, or from any number of storage devices.

When programming is received from cable and/or satellite service providers, it is common for the service provider to provide a customer with a “set top box” that acts as an interface between the communications medium and the television. However, some televisions now have similar capabilities built in. Likewise, if video programming is to be received via the Internet, it is common for the user to employ an interface device that is connected to the Internet and which provides a signal that the television can use to display the video programming.

Although the above examples related to televisions, it is also possible to receive and play video programming on alternate display devices, such as computer display screens. Desktop and laptop computers, as well as various other portable computing devices are now capable of receiving video programming from the Internet or from other sources, and displaying such video programming in a manner similar to a television.

The expanding availability of high speed Internet access has also allowed users to conduct audio and video conferencing with other parties using desktop and laptop computers, portable computing devices and televisions. And such video conferencing can be conducted at the same time that a video program is being played on the display device.

FIG. 1 illustrates a television 100 that includes a main display area 102 for displaying a video program received from a content provider. The television also provides a plurality of windows 110, 112, 114 and 116 which can be used to display things other than the video program appearing in the main display area 102. A computer display could provide virtually identical functionality, where a video program is displayed on a main display area, and where multiple windows are provided to display things other than the video program.

With a television or computer display as illustrated in FIG. 1, it is possible for a first user to conduct a video conference with one or more other users at the same time the user is watching a video program. Video feeds from the other users would appear in the windows 110, 112, 114 and 116. And the audio produced by the other users would be superimposed on the audio of the video program and played through the same speakers. Alternatively, the audio feeds from the other users could be played to the first user through a different set of speakers via the video conferencing link.

The above-described functionality allows multiple users at different physical locations to watch the same video program at the same time, and the users can also talk and interact with each other while the video program is being displayed. This creates an atmosphere similar to the one which would exist if the different users were all physically present at the same location and were watching the video program on the same display device.

One problem with such a system relates to the synchronization of the video program being displayed on the different users' display devices. Even when two users are receiving a video program from the same content provider, transmission variations often result in same video program being displayed on two different display devices at two different locations at slightly different times. And when two users are receiving the same video program from different content providers, this problem can become even worse.

When a video program is displayed on two different display devices at slightly different points in time, multiple problems can occur. A first user at a first location may hear the video program in the background of a second user's video feed as part of the video conference link. This means the first user will hear the audio portions of the video program twice, once from his own display device, and again at a slightly different time through the video conference link to the second user. And hearing the same audio information twice at different points in time can be disorienting or confusing.

In addition, if the video program is a live broadcast, such as a sporting event, a first user who is watching the advanced video feed will react to actions which occur during the broadcast before a second user watching the delayed video feed sees the actions. This can be somewhat frustrating for the person watching the delayed video feed.

### BRIEF DESCRIPTION OF THE DRAWINGS

FIG. 1 is a diagram illustrating an existing video display that includes multiple embedded windows with sub-displays;

FIG. 2 is diagram illustrating how televisions in different locations are coupled to various video content providers and to a video conference services provider;

FIG. 3 illustrates the logical relationships between multiple televisions and audio/video units positioned at different locations and elements of a first embodiment of a system for synchronizing the presentation of a video program on those televisions in accordance with the present invention; and

FIG. 4 illustrates the logical relationships between multiple televisions and audio/video units positioned at different locations and elements of a second embodiment of a system for synchronizing the presentation of a video program on those televisions in accordance with the present invention.

### DETAILED DESCRIPTION OF PREFERRED EMBODIMENTS

In the following discussion, the terms “video,” “video program” and “video presentation” are used to refer to video programs that are presented to users on a display device. These terms are intended to encompass video programs such as television programs and movies, as well as video presentations that do not include an audio track. These terms also cover any sort of video programming, video recordings or video presentations, regardless of how they are captured, created or delivered to an end user. The terms are intended to encompass virtually any material which could be displayed to a user on a display device such as a television or a computer display screen.

In addition, multiple different types of video display devices will be discussed. The term “display device” is intended to encompass any device or combination of devices that allow a user to watch a video program. For example, the term display device encompasses any type of television, audio/video projectors, computer display screens with or without associated speakers, hand-held devices such as smart phones having a display screen and a speaker, as well as any other device or combination of devices which can play the audio and video portions of a video program.

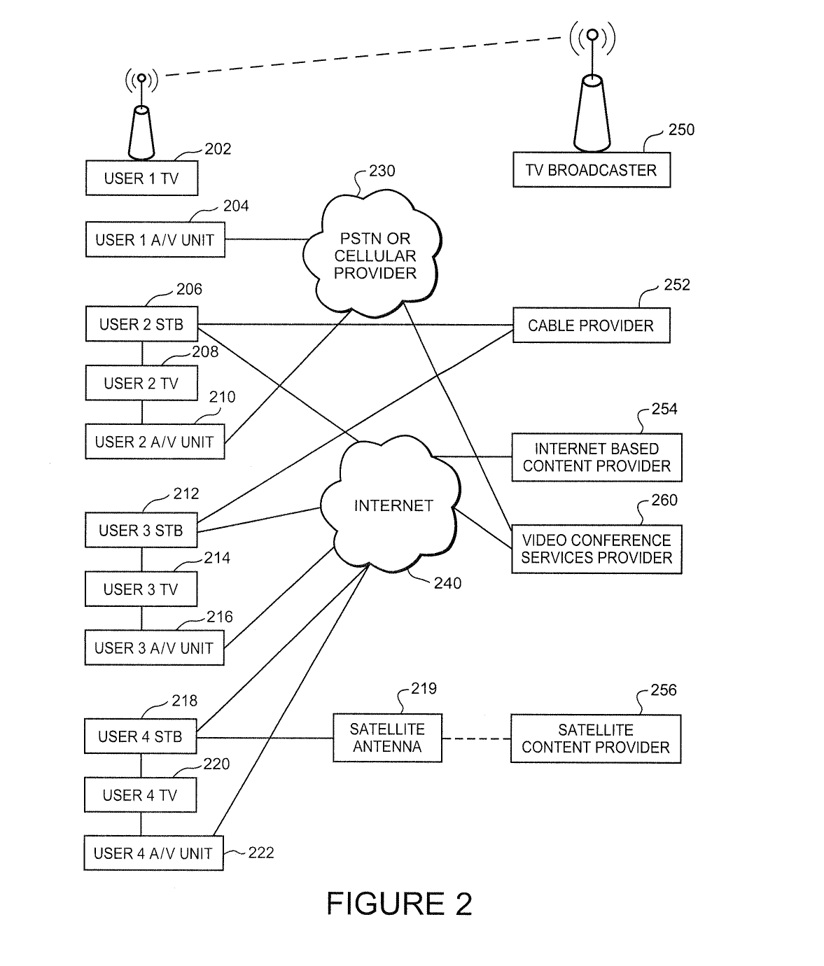

The invention relates to systems and methods used to synchronize the display of a video program on multiple display devices. However, before the synchronization methods and systems are described, a description of how various display devices and audio/video conferencing devices can be coupled to each other will be provided in conjunction with FIG. 2.

As illustrated in FIG. 2, a first user television 202 receives video programming content from a TV broadcaster 250. That first user also has an audio/video unit 204, such as a telephone, that is connected to a telephony system, such as a publically switched telephone network (PSTN) or a cellular telephone service provider. This set of equipment would allow the first user to watch a video program provided by the TV broadcaster 250 at the same time the first user speaks to other users over the telephone 204 as part of a normal telephone call, or as part of a telephone conference call with other users.

A second user has a television 208 that is connected to a video interface device, such as a set top box 206. The second user's set top box 206 receives video programming content from a cable television service provider 252. The second user's set top box 206 is also connected to the Internet 240, which allows the second user to receive and watch video programming from an Internet based content provider 254. The second user also has an audio/video unit, such as a telephone, that is coupled to the telephony system and network 230.

When the first and second users have the equipment described above, the first and second users can watch the same video program while they are speaking with each other over their respective telephones. The first user would be receiving the video program from the TV broadcaster 250, while the second user obtains the same video program via the cable television service provider 252. Due to the different sources of the video program, it is unlikely that the video program would be displayed on the first user's television 202 and the second user's television 208 in a synchronized fashion.

A third user television 214 is also connected to a set top box 212. The third user's set top box 212 is also connected to the cable television service provider 252 and to the Internet 240. The third user also has an audio/video unit 216 that is coupled to the Internet 240.

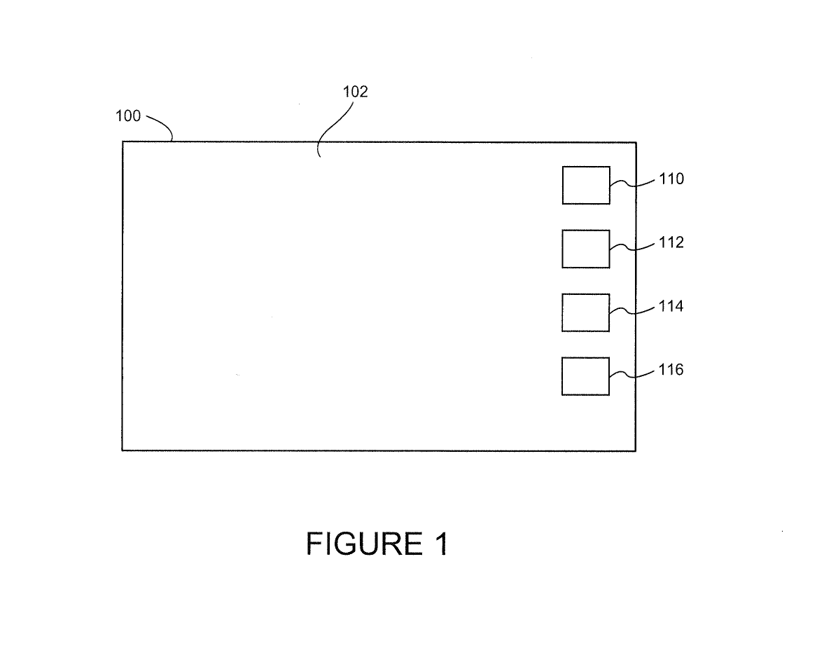

The third user's audio/video unit could be a computer with a video capability, or possibly a smartphone with video conferencing abilities, such as the Apple iPhone™. This allows the third user to conduct a video conference call with other users. The third user's audio/video unit 216 may also be integrated with the third user's television 214 and/or with the third user's set top box 212. This would allow the third user to watch a video program on his television 214, and also conduct a video conference with another user, where the video feed from the other user appears in a window on the third user television, as illustrated in FIG. 1.

The second user and the third user could watch the same video program at the same time, and both users would obtain the video program from the cable television service provider 252. However, due to transmission delays, it is unlikely that the video program would be shown on the second user's television 208 and the third user's television 214 in a synchronized fashion.

A fourth user's television 220 is also coupled to a set top box 218 which receives a signal from a satellite television services provider 256 via a satellite antenna 219. The fourth user also has an audio/video unit 222 that is coupled to the Internet 240. The fourth user's audio/video unit is also coupled to the fourth user's television 220 and/or the fourth user's set top box 218 so that the user can watch a video program and conduct a video conference with one or more other users.

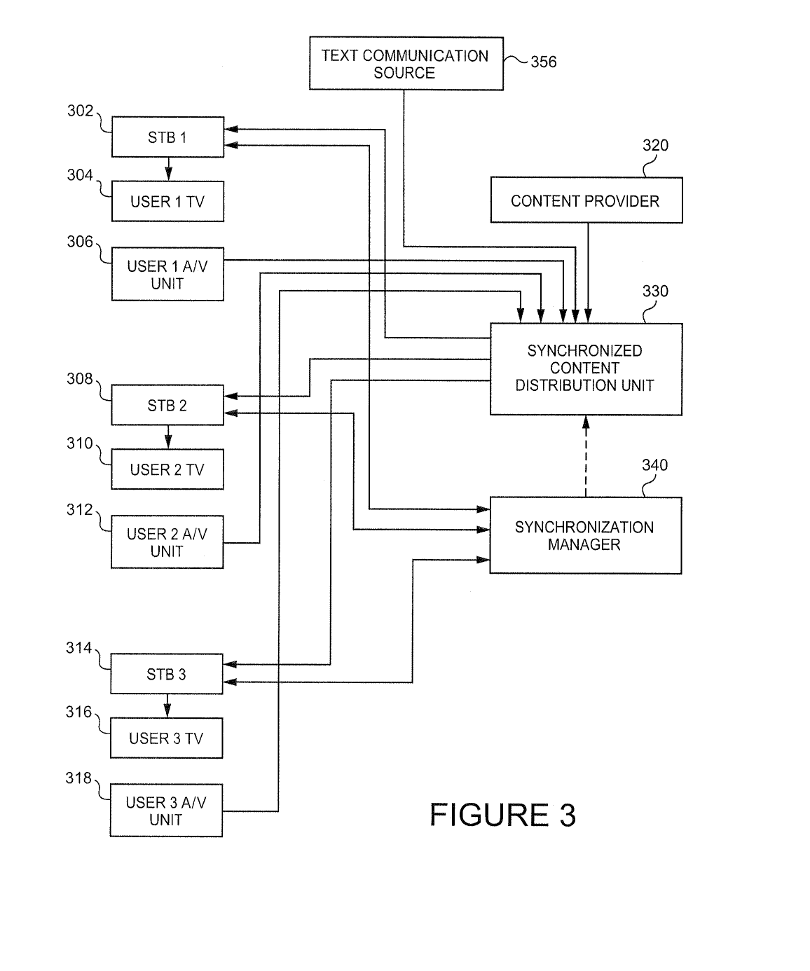

A first system and method for synchronizing the display of a video program on multiple display devices in accordance with the present invention will now be described in conjunction with FIG. 3. FIG. 3 illustrates set top boxes 302, 308, 314, display devices 304, 310, 316 and audio/video units 306, 312, 318 for three different users. FIG. 3 also illustrates a content provider 320 which provides video programming content and a synchronized content distribution unit 330. An optional synchronization manager 340 is also illustrated.

The lines connecting the elements in FIG. 3 are intended to illustrate communications links between these devices. Those communications links could be established in multiple different ways. The links could be established via one or more of the elements described earlier in connection with FIG. 2, including the Internet, a cable connection provided by a cable television service provider, a satellite signal from a satellite television service provider, a wired or wireless telephone signals, a broadcast signal from a television broadcaster, or some other medium or method.

In this embodiment, the synchronized content distribution (SCD) unit 330 receives a video program from the content provider 320. The SCD unit 330 then sends the video program to the set top boxes 302, 308, 314 of the three users. The set top boxes feed the video program to the users' display devices 304, 310, 316.

In some embodiments, the fact that the video program is being sent to all of the display devices by a single device may be sufficient for the video program to appear on all three display devices 304, 310, 316 in a synchronized fashion.

In other embodiments, the SCD unit 330 may encode the video program signal sent to the set top boxes 302, 308, 314 with timing or synchronization information. The set top boxes 302, 308, 314 would then use this encoded information to cause the video program to be displayed on all three user display devices 304, 310, 316 in a synchronized fashion. For example, one or more of the set top boxes may use this encoded information to slightly delay the display of the video program on its associated display device so that the display device shows the video program in synchronization with the other display devices.

In still other embodiments, the SCD unit may receive timing or synchronization information sent from the set top boxes 302, 308, 314. The SCD unit would then use this information to control when the video program is sent to each of the set top boxes 302, 308, 314. By slightly varying when each set top box receives the video program signal, the SCD unit can ensure the video program is displayed on all three display devices in a synchronized fashion.

In still other embodiments, the SCD unit might use the synchronization information to create delay signals for each of the set top boxes. The delay signals could be transmitted from the SCD unit to the set top boxes, or the delay information might be encoded in the video program signal sent to the set top boxes. The set top boxes would then use the delay information to selectively delay the display of the video program so that the video program is displayed on all display devices in a synchronized fashion.

As also illustrated in FIG. 3, the SCD unit may receive audio and/or video feeds from the audio/video units 306, 312, 318 of the three users. The SCD unit could then combine these audio/video feeds with the video program received from the content provider to produce a combined video program. The combined video program would then be sent to the set top boxes.

In alternate embodiments, one or more of the user's audio/video units 306, 312, 318 may provide a stream of text communications from a user. In that instance, the text stream provided by a user would be combined with the video program received from the content provider to produce a combined video program. Thus, a combined video program could include the video program from a content provider, an audio feed from a first user, a video feed from a second user, and a text feed from a third user. Any other combination of communications streams from the users could also be combined with a video program from a content provider to produce a combined video program.

In still other embodiments, a separate text communications source 356 could provide a text communications stream from some other source. The text stream could be provided by a party that is not watching the video program being viewed by other users. However, if the synchronized content distribution unit 330 combines the text communication stream from the text communication source 356 with the video program from the content provider 320 and the audio/video streams from the users, and then ensures that the combined video program is displayed to all users in a synchronized fashion, then all users will see and react to the text communications stream from the text communications source 356 at the same time.

The combined video program could, for example, cause the display devices 304, 310, 316 to play an image as illustrated in FIG. 1, where the video program received from the content provider 320 is played on a main display area, and where text and/or video feeds from the three users' audio/video units 306, 312, 318 are presented in windows. If this is the case, the SCD unit might produce a single combined video program which is sent to all of the users. This would mean that each user would see windows with the text/video feeds from the other two users, as well as a window which displays his own text/video feed.

In other embodiments, the SCD unit could create a different combined video program for each user. For example, a first combined video program sent to the first user would include the video program received from the content provider 320, as well as two windows that display the text/video feeds from the second and third users. Similarly, a second combined video program sent to the second user would include the video program received from the content provider 320, as well as two windows that display the text/video feeds from the first and third users.

Of course, the combined video program might also include a separate window that displays text from a text communications source 356 in addition to the text/video feeds from the users.

The windows depicted in FIG. 1 are stationary, in a stacked configuration along the right side of the display. Alternatively, the windows could be moved to other locations. In some embodiments, the windows could be located in user selected areas of preference anywhere on the display. In such an embodiment, either the user viewing the display, or the user whose image is depicted in the window, could control the location.

In an alternate embodiment, the windows can moved automatically about the screen based on activity in the video program. For example, if there is a temporary high degree of interest in what is being depicted near the right side of the display, the windows will move to areas of a lower degree of interest. The level of interest can be determined by one or more methods including but not limited to motion detection processing, color analysis, predetermined timing of the video program and the like. Also some type of context analysis could be performed on the images being displayed to determine the best location for the windows.

In other embodiments, a synchronization manager 340 is used to help synchronize the presentation of the video program on the three display screens 304, 310, 316. In this embodiment, the synchronization manager could receive synchronization signals from the set top boxes 302, 308, 314. The synchronization manager 340 uses the information in the synchronization signals to create individual delay signals for each set top box. The various delay signals are then transmitted to their respective set top boxes, and each set top box uses its received delay signal to slightly delay the presentation of the video program received from the SCD unit 330 so that the video program is displayed on the three display devices in a synchronized fashion.

In still other embodiments, the synchronization manager 340 could use the information in the synchronization signals received from the set top boxes to create delay information that is transmitted to the SCD unit. The SCD unit could then selectively delay the transmission of the video program to individual ones of the set top boxes to cause the video program to be displayed in a synchronized fashion. Alternatively, the SCD manager might encode delay information into the video program signal sent to the set top boxes, and the set top boxes could use the encoded information to cause the video program to be displayed in a synchronized fashion.

In some instances, the synchronization signals sent from the set top boxes to the SCD unit 330 or the synchronization manager 340 could include the audio track from the video program which has been sent to the set top boxes. The SCD unit or the synchronization manager could then compare the sound tracks received from each of the set top boxes to determine how much each set top box needs to delay the presentation of the video program to achieve a synchronized presentation across all display devices.

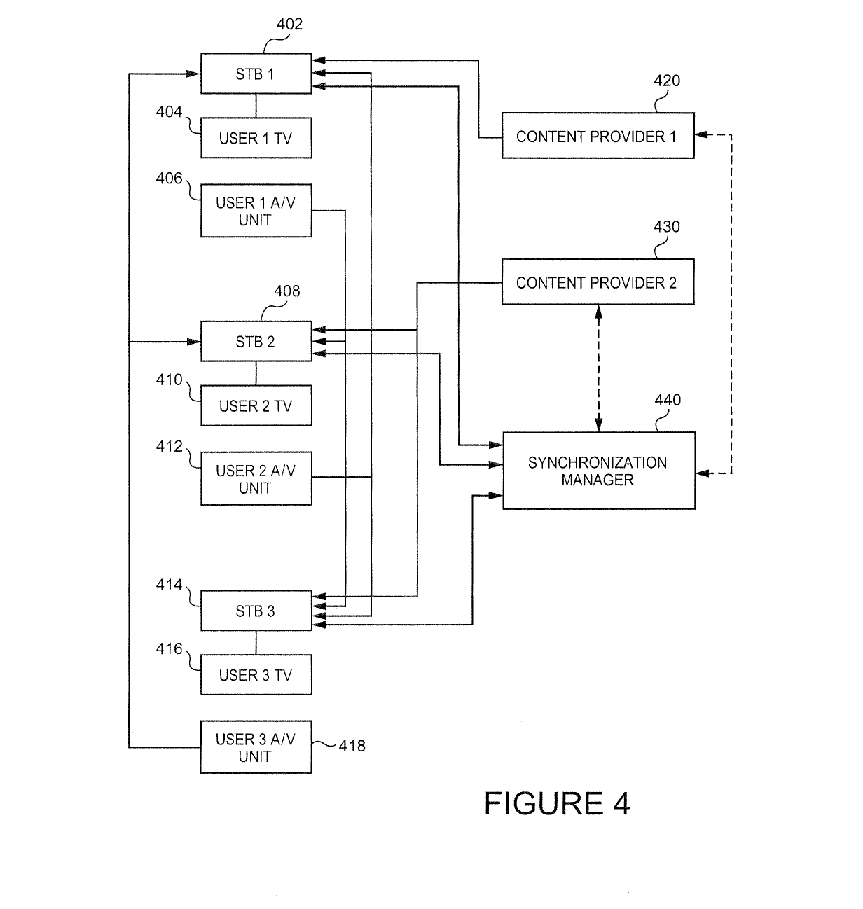

FIG. 4 illustrates a different way of achieving synchronized display of a video program on multiple display devices. In this embodiment, one or more content providers send the same video program directly to the set top boxes 402, 408, 414 of three users. The set top boxes then send synchronization signals to a synchronization manager 440. The synchronization manager uses the information in the synchronization signals to generate individual delay signals for each set top box. The delay signals are then sent to the respective set top boxes, and the set top boxes use this information to selectively delay the presentation of the video program so that the video program is displayed on all display devices 404, 410, 416 in a synchronized fashion.

As illustrated in FIG. 4, a first content provider 420 provides the video program to the first user's set top box 402, while a second content provider 430 sends the same video program to the second and third user's set top boxes 408, 414. Despite the fact that different content providers are supplying the users, the synchronization manager 440 can ensure that the video program is displayed in a synchronized fashion.

In some alternate embodiments, the synchronization manager 440 might send delay signals to the content providers 420, 430. This delay signal could be used by the content providers themselves to delay their transmissions to the set top boxes. Alternatively, the content providers might encode this delay information into the video program signal being sent to the set top boxes, and the individual set top boxes would then used the encoded delay information to cause the video program to be displayed in synchronized fashion by all the display devices.

As also illustrated in FIG. 4, each of the users may also have audio/video units 406, 412, 418 that provide audio and/or video feeds to the set top boxes of the other users. When this occurs, each set top box can combine the video program received from one of the content providers with the audio/video feed from the other users to create a combined video program that is then displayed on the display devices. Here again, the combined video program could resemble the one illustrated in FIG. 1, where the video program is displayed on a main display area, and wherein windows in the display provide the video feeds from the other users.

In the embodiments discussed above, set top boxes receive a video program signal and provide the video program signal to a display device. In alternate embodiments, the functions performed by the set top boxes could be performed by the display device itself. In still other embodiments, some or all of the functions could be performed by the devices that send the video signal to the display devices.

While the technology has been described in connection with what is presently considered to be the most practical and preferred embodiments, it is to be understood that the technology is not to be limited to the disclosed embodiments, but on the contrary, is intended to cover various modifications and equivalent arrangements included within the spirit and scope of the appended claims.

1. A method of synchronizing the presentation of combined video programs on multiple display devices, comprising:
receiving a video program from a content provider;
receiving at least first and second communications streams from first and second users, respectively;
combining the video program and the first communications stream to create a first combined video program;
combining the video program and the second communications stream to create a second combined video program; and
causing the first and second combined video programs to be displayed first and second user display devices such that the video program is displayed substantially simultaneously on the first and second user display devices.

2. The method of claim 1, wherein the first and second combined video programs include synchronization information that can be used to display the first and second combined video programs.

3. The method of claim 1, further comprising receiving synchronization information from video control devices of the first and second users, and wherein during the causing step the received synchronization information is used to display the first and second combined video programs.

4. The method of claim 3, wherein the causing step comprises generating delay signals for the video control devices of the first and second users based on the received synchronization information, and transmitting the delay signals to the video control devices.

5. (canceled)

6. The method of claim 1, wherein the combining steps comprise creating a different first and second combined video program for the first and second user display devices.

7. The method of claim 6, wherein the causing step comprises transmitting the different first and second combined video programs to the user display devices for which they were created.

8. The method of claim 1, wherein receiving at least first and second communications streams comprises receiving a video communications stream from at least one user.

9. The method of claim 1, wherein receiving at least first and second communications streams comprises receiving a text communications stream.

10. A method of displaying a video program on a first display device in synchronization with the display of the video program on another display device, comprising:
receiving a video program from a content provider at a first video controller associated with a first display device, wherein synchronization information is encoded or embedded in the video program;
receiving at least one communications stream at the first video controller;
combining, with the first video controller, the video program and the at least one communications stream to generate a first combined video program; and
using the synchronization information to cause the first combined video program to be played on the first display device in substantial synchronization with the display of another combined video program on another display device.

11. The method of claim 10, wherein the synchronization information comprises a delay signal, and wherein the delay signal is used to play the combined video program on the first display device.

12. The method of claim 10, further comprising:
sending a synchronization signal from the first video controller to a synchronization unit, wherein the synchronization information that is embedded in the video program comprises a delay signal that was generated by the synchronization unit;
and
using the synchronization information comprises using the delay signal to play the combined video program.

13. The method of claim 12, wherein the synchronization signal comprises at least an audio portion of the video program received from a content provider.

14. The method of claim 12, wherein the synchronization signal comprises timing information that is based on the video program received from a content provider.

15. The method of claim 12, wherein using the delay signal comprises delaying the display of the combined video program on the first display device based on the delay signal.

16. The method of claim 10, wherein receiving at least one communications stream comprises receiving at least one video communications stream from a user.

17. The method of claim 10, wherein receiving at least one communications stream comprises receiving at least one text communications stream.

18. The method of claim 10, wherein receiving at least one communications stream from a user comprises receiving a video communications stream from a first user and receiving a text communications stream.

19. A system for synchronizing the presentation of combined video programs on multiple display devices, comprising:
means for receiving a video program from a content provider;
means for receiving at least first and second communications streams from first and second users;
means for combining the video program and the first communications stream to create a first combined video program;
means for combining the video program and the second communications stream to create a second combined video program; and
means for causing the first and second combined video programs to be displayed on first and second user display devices such that the video program is displayed substantially simultaneously on the first and second user display devices.

20. A system for displaying a video program on a first display device in synchronization with the display of the video program on another display device, comprising:
means for receiving a video program from a content provider at a first video controller associated with a first display device, wherein synchronization information is encoded or embedded in the video program;
means for receiving at least one communications stream from a user at the first video controller;
means for combining, with the first video controller, the video program and the at least one communications stream to generate a first combined video program; and
means for using the synchronization information to cause the first combined video program to be played on the first display device in substantial synchronization with the display of another combined video program on another display device.

21. The method of claim 2, wherein the synchronization information is encoded or embedded in the first and second combined video programs.

22. The system of claim 19, wherein the first and second combined video programs include synchronization information that can be used to display the first and second combined video programs.

23. The system of claim 22, wherein the synchronization information is encoded or embedded in each of the first and second combined video programs.

24. The system of claim 19, wherein the first and second combined video programs are different combined video programs.

25. The system of claim 24, wherein the means for causing transmits the first and second combined video programs to the user display devices for which they were created.

26. The system of claim 20, wherein the synchronization information comprises a delay signal, and wherein the delay signal is used to play the combined video program on the first display device.

27. The system of claim 20, further comprising means for sending a synchronization signal from the first video controller to a synchronization unit, wherein the synchronization information that is embedded in the video program comprises a delay signal that was generated by the synchronization unit, and wherein the means for using the synchronization information uses the delay signal to play the combined video program.

28. The system claim 27, wherein the synchronization signal comprises at least an audio portion of the video program received from a content provider.

29. The system of claim 27, wherein the synchronization signal comprises timing information that is based on the video program received from a content provider.

30. The system of claim 20, wherein the means for receiving at least one communications stream receives at least one video communications stream from a user.

31. The system of claim 20, wherein the means for receiving at least one communications stream receives at least one text communications stream.
